(19) United States
(12) Patent Application Publication
(10) Pub. No.: US 2024/0339854 A1
(43) Pub. Date: Oct. 10, 2024

(54) BOOST CHARGING CONTROL METHOD, ELECTRIC DRIVE APPARATUS, AND VEHICLE

(71) Applicant: ZF Friedrichshafen AG, Friedrichshafen (DE)

(72) Inventors: Yijin Qin, Shanghai (CN); Yulin Chen, Shanghai (CN)

(73) Assignee: ZF Friedrichshafen AG, Friedrichshafen (DE)

(21) Appl. No.: 18/628,161

(22) Filed: Apr. 5, 2024

(30) Foreign Application Priority Data
Apr. 6, 2023 (CN) 202310359438.8

(51) Int. Cl. H02J 7/00; B60L 53/24

(52) U.S. Cl. CPC H02J 7/007182; B60L 53/24; B60L 2240/547; H02J 2207/20; H02J 2310/48

(57) ABSTRACT

A boost charging control method is disclosed to improve a large rotor temperature rise of a three-phase alternating current motor during boost charging. The method includes obtaining a condition parameter being associated with a duty cycle of a control signal of a power switch unit of the inverter, and the condition parameter including a battery voltage and a charging pile voltage, selecting a charging mode based on the condition parameter, where the charging mode includes two-phase charging and three-phase charging, wherein in the two-phase charging, the power switch unit of the inverter is controlled such that two phase windings of the three-phase motor are used for boost charging of the battery, and in the three-phase charging, the power switch unit of the inverter is controlled such that three phase windings of the three-phase motor are used for boost charging of the battery, and controlling charging based on the charging mode.

### CROSS-REFERENCE TO RELATED APPLICATION

This application claims priority to Chinese Application No. 202310359438.8, filed on Apr. 6, 2023, the entirety of which is hereby fully incorporated by reference herein.

### FIELD

The present disclosure relates to the field of battery charging, and in particular, to a boost charging control method, an electric drive apparatus, and a vehicle.

### BACKGROUND

When boost charging is performed on a battery using a three-phase alternating current motor, there are fluctuations in phase currents of the three-phase alternating current motor, and therefore, a magnetic field inside the motor alternates, which causes a rotor iron loss of the motor, resulting in a large rotor temperature rise of the motor.

### SUMMARY

An objective of the present disclosure is to provide a boost charging control method, an electric drive apparatus, and a vehicle, to improve a case of a large rotor temperature rise of a three-phase alternating current motor during boost charging.

According to a first aspect, the present disclosure provides a boost charging control method performed on a battery using a three-phase motor and an inverter. According to an embodiment of the present disclosure, the method includes at least the following steps: obtaining a condition parameter, the condition parameter being associated with a duty cycle of a control signal of a power switch unit of the inverter, and the condition parameter including a battery voltage and a charging pile voltage; selecting a charging mode based on the condition parameter, where the charging mode includes two-phase charging and three-phase charging, in the two-phase charging, the power switch unit of the inverter is controlled such that two phase windings of the three-phase motor are used for boost charging of the battery, and in the three-phase charging, the power switch unit of the inverter is controlled such that three phase windings of the three-phase motor are used for boost charging of the battery; and controlling charging based on the charging mode.

In one or more embodiments, the condition parameter includes a ratio of the battery voltage to the charging pile voltage.

In one or more embodiments, the selecting a charging mode based on the condition parameter includes selecting the charging mode based on the ratio, and the selecting the charging mode based on the ratio includes: selecting the three-phase charging when the ratio is less than or equal to a first threshold; selecting the two-phase charging when the ratio is greater than or equal to a second threshold; and keeping the charging mode unchanged when the ratio is greater than the first threshold and less than the second threshold.

In one or more embodiments, the first threshold is 1.5.

In one or more embodiments, the second threshold is 2.

In one or more embodiments, the selecting a charging mode based on the condition parameter includes selecting the charging mode based on the ratio, and the selecting the charging mode based on the ratio includes: selecting the three-phase charging when the ratio is less than or equal to a third threshold; and selecting the two-phase charging when the ratio is greater than the third threshold.

In one or more embodiments, the third threshold is 1.7.

In one or more embodiments, in the two-phase charging, the power switch unit of the inverter is controlled such that there is a 180-degree phase difference between charging currents of the two phase windings of the three-phase motor; and in the three-phase charging, the power switch unit of the inverter is controlled such that there is a 120-degree phase difference between charging currents of the three phase windings of the three-phase motor.

According to a second aspect, the present disclosure provides an electric drive apparatus. According to an embodiment of the present disclosure, the electric drive apparatus includes an inverter, a three-phase motor, and a controller, the inverter being configured to perform power conversion between a battery and the three-phase motor, and the controller being configured to control on and off of a power switch unit of the inverter, where the controller is configured to perform the above boost charging control method, for performing boost charging on the battery using the three-phase motor and the inverter.

According to a third aspect, the present disclosure provides a vehicle.

According to an embodiment of the present disclosure, the vehicle includes the above electric drive apparatus.

The embodiments of the present disclosure have at least the following advantageous effect:

A two-phase charging or three-phase charging mode that is optimal for a system can be selected based on a real-time status of the system, to reduce the temperature of a rotor of the motor and increase the charging efficiency of the system.

The above and other features, properties, and advantages of the present disclosure will become more apparent from the following description with reference to the drawings and the embodiments.

### BRIEF DESCRIPTION OF THE DRAWINGS

FIG. 1 is a schematic diagram of a battery boost charging circuit in three-phase charging;

FIG. 2 is a diagram of phase current waveforms of a three-phase alternating current motor in three-phase charging;

FIG. 3 is a schematic diagram of a battery boost charging circuit in two-phase charging;

FIG. 4 is a diagram of phase current waveforms of a three-phase alternating current motor in two-phase charging;

FIG. 5 is a diagram of phase current waveforms and control signal waveforms of a three-phase alternating current motor at an optimal operating point of three-phase charging;

FIG. 6 is a diagram of phase current waveforms and control signal waveforms of a three-phase alternating current motor at an optimal operating point of two-phase charging; and

FIG. 7 is a schematic diagram of an electric drive apparatus.

### DETAILED DESCRIPTION

Reference will now be made in detail to the embodiments of the present disclosure, and one or more examples of which are illustrated in the drawings. Each example is provided to explain the present disclosure, but not to limit the present disclosure. In fact, it will be apparent to those skilled in the art that various modifications and variations can be made in the present disclosure without departing from the scope or spirit of the present disclosure. For example, the features illustrated or described as part of an embodiment can be used with another embodiment to provide a further embodiment. Therefore, the present disclosure is intended to cover the modifications and variations that fall within the scope of the appended claims and their equivalents.

It should be noted that these and other subsequent drawings are merely examples and not drawn to scale, and should not be construed as limiting the scope of protection actually claimed in the present disclosure.

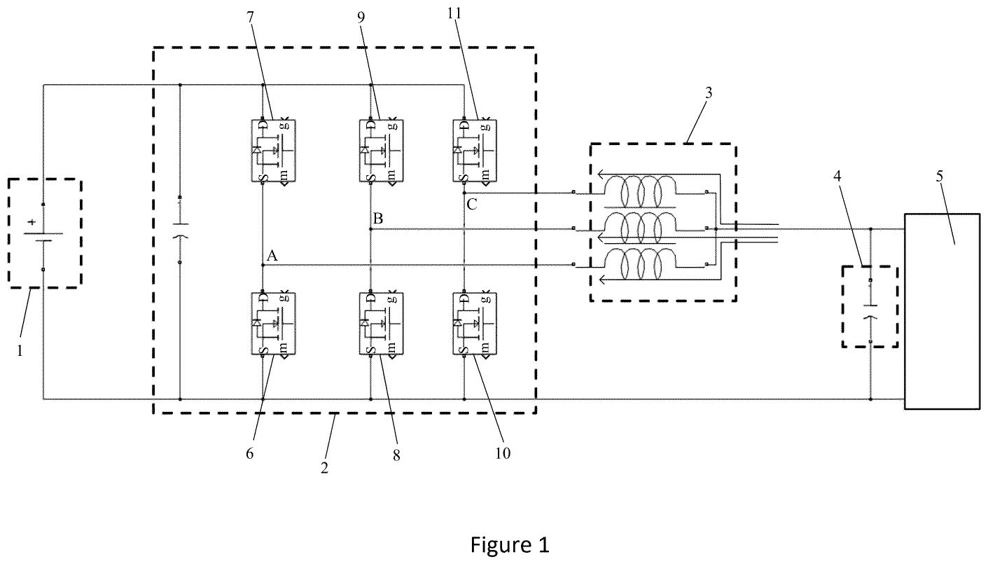

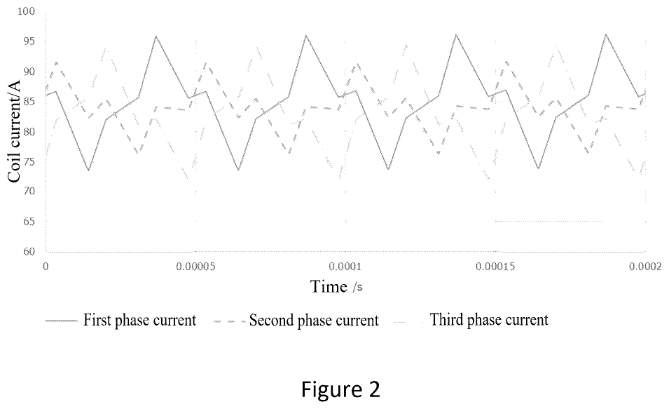

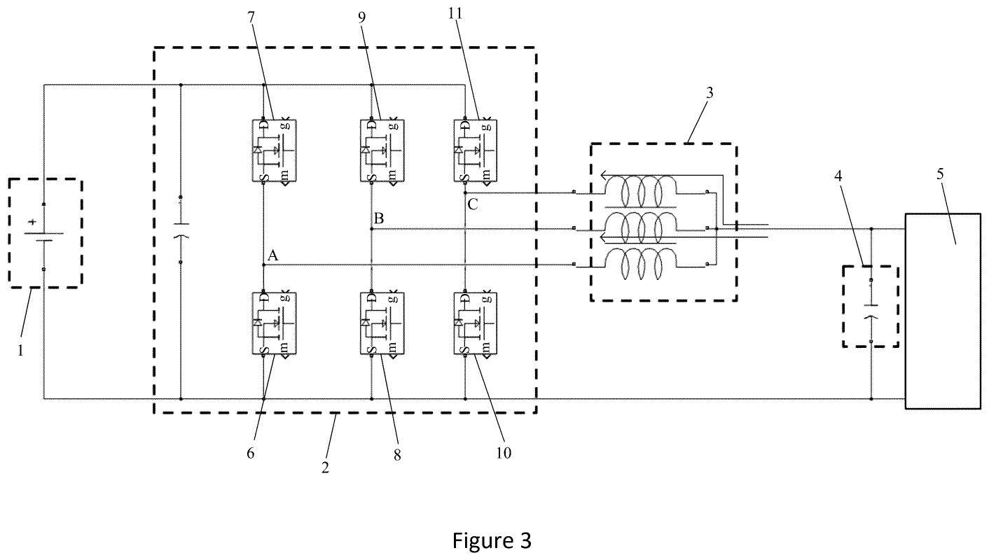

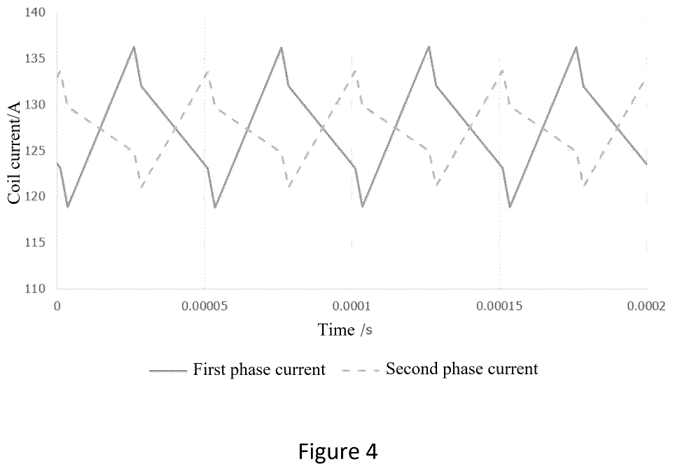

FIG. 1 and FIG. 3 each show a structure of a battery boost charging circuit. As shown in FIG. 1 and FIG. 3, the battery boost charging circuit includes a battery 1, a three-phase three-arm inverter 2, a three-phase alternating current motor 3, a support capacitor 4, and a charging pile 5, where the battery 1 is exemplarily a traction battery, the three-phase alternating current motor 3 has, for example, three phase windings constituting a star connection, and the inverter 2 is configured to perform power conversion between the battery 1 and the three-phase motor 3. The battery boost charging circuit in FIG. 1 is in a three-phase charging mode, where all power switch units 6 to 11 of the three-phase three-arm inverter 2 are on or off, and the three phase windings of the three-phase alternating current motor 3 alternately perform boost charging on the battery 1. FIG. 2 shows phase current waveforms of the three phase windings of the three-phase alternating current motor 3. As shown in FIG. 2, due to a mutual inductance effect, each phase current changes with changes in the other two phase currents during a rising or falling process, and a current waveform of each phase current has six turning points in one period, increasing phase current harmonics. In this way, a magnetic field inside the three-phase alternating current motor 3 alternates, which causes a rotor iron loss of the three-phase alternating current motor 3, resulting in a large rotor temperature rise of the three-phase alternating current motor 3. The battery boost charging circuit in FIG. 3 is in a two-phase charging mode, where all the power switch units 6 to 11 of the three-phase three-arm inverter 2 are on or off, and two phase windings of the three-phase alternating current motor 3 alternately perform boost charging on the battery 1. FIG. 4 shows phase current waveforms of the two phase windings of the three-phase alternating current motor 3. As shown in FIG. 4, due to a mutual inductance effect, each phase current changes with a change in the other phase current during a rising or falling process, and a current waveform of each phase current has four turning points in one period, increasing phase current harmonics. In this way, a magnetic field inside the three-phase alternating current motor 3 alternates, which causes a rotor iron loss of the three-phase alternating current motor 3, resulting in a large rotor temperature rise of the three-phase alternating current motor 3.

The boost charging control method is illustrated below in conjunction with the battery boost charging circuit.

The boost charging control method includes obtaining a condition parameter, the condition parameter being associated with a duty cycle of a PWM control signal which controls on and off of each of the power switch units 6 to 11 of the three-phase three-arm inverter 2, to affect the duty cycle of the control signal. Different condition parameters correspond to different control signal duty cycles, such that phase current fluctuations of the windings of the three-phase alternating current motor 3 behave differently, thereby affecting the rotor temperature rise of the three-phase alternating current motor 3. Therefore, the condition parameters are used to guide subsequent charging mode selection. There may be one or more condition parameters, which include at least a voltage of the battery 1 and a voltage of the charging pile 5, as described in detail as follows.

The boost charging control method further includes selecting a charging mode based on the condition parameter, where the charging mode includes two-phase charging and three-phase charging. In the two-phase charging mode, the power switch units 6 to 11 of the three-phase three-arm inverter 2 are on or off, such that two phase windings of the three-phase alternating current motor 3 alternately perform boost charging on the battery 1. In the three-phase charging mode, the power switch units 6 to 11 of the three-phase three-arm inverter 2 are on or off, such that the three phase windings of the three-phase alternating current motor 3 alternately perform boost charging on the battery 1. For different control signal duty cycles, the two-phase charging and the three-phase charging cause the phase current fluctuations of the windings of the three-phase alternating current motor 3 to behave differently. In the case of a specific control signal duty cycle (or a control signal duty cycle within a specific range), different charging modes result in different phase current fluctuations of the windings of the three-phase alternating current motor 3. A phase current fluctuation of the windings during the two-phase charging is less than a phase current fluctuation of the windings during the three-phase charging, or the phase current fluctuation of the windings during the two-phase charging is greater than the phase current fluctuation of the windings during the three-phase charging. Therefore, in the case of a specific control signal duty cycle (or a control signal duty cycle within a specific range), the use of the two-phase charging or the three-phase charging enables the windings to produce a smaller phase current fluctuation, thereby reducing the rotor temperature rise of the three-phase alternating current motor 3.

The boost charging control method further includes controlling charging of the battery based on the selected charging mode. With continued reference to FIG. 1, how to control single-phase boost charging of the battery 1 is described first. Taking a phase A as an example, a PWM control signal is sent to a bridge arm of the phase A of the three-phase three-arm inverter 2. During on-time in each PWM control signal period, the first power switch unit 6 on the bridge arm of the phase A of the three-phase three-arm inverter 2 is controlled to be on and the second power switch unit 7 is controlled to be off, while the third power switch unit 8, the fourth power switch unit 9, the fifth power switch unit 10, and the sixth power switch unit 11 on bridge arms of the other two phases B and C are all controlled to be off. In this case, windings of the phase A are on, a current increases, an inductor starts to store energy, and there is a positive voltage at a right end and a negative voltage at a left end of the inductor of the phase A. During off-time in each PWM control signal period, the first power switch unit 6 of the phase A of the three-phase three-arm inverter 2 is controlled to be off and the second power switch unit 7 is controlled to be on, while the third power switch unit 8, the fourth power switch unit 9, the fifth power switch unit 10, and the sixth power switch unit 11 of the other two phases B and C are all controlled to be off. In this case, the inductor starts to discharge electricity, the current decreases, and there is a positive voltage at the left end and a negative voltage at the right end of the inductor of the phase A. The inductor voltage of the phase A is superimposed with a charging voltage of the charging pile 5 for charging the battery 1, to implement boost charging of the battery 1. With continued reference to FIG. 1, when the charging mode is the three-phase charging, PWM control signals are sent to a bridge arm of the phase A, a bridge arm of the phase B, and a bridge arm of the phase C of the three-phase three-arm inverter 2. There is a 120-degree phase difference between the PWM control signal of the bridge arm of the phase A, the PWM control signal of the bridge arm of the phase B, and the PWM control signal of the bridge arm of the phase C, to produce a 120-degree phase difference between on and off states of the power switch units 6 and 7 of the bridge arm of the phase A, the power switch units 8 and 9 of the bridge arm of the phase B, and the power switch units 10 and 11 of the bridge arm of the phase C, such that the inductor of the phase A, an inductor of the phase B, and an inductor of the phase C alternately perform energy storage for charging and electricity discharge for boost. There is a 120-degree phase difference between charging currents of windings of the phase A, windings of the phase B, and windings of the phase C, to alternately perform boost charging of the battery 1. With continued reference to FIG. 3, when the charging mode is the two-phase charging, PWM control signals are sent to bridge arms of two phases of the three-phase three-arm inverter 2. Exemplarily, the PWM control signals are sent to the bridge arm of the phase B and the bridge arm of the phase C. The first power switch unit 6 and the second power switch unit 7 on the bridge arm of the phase A are both off. There is a 180-degree phase difference between the PWM control signal of the bridge arm of the phase B and the PWM control signal of the bridge arm of the phase C, to produce a 180-degree phase difference between on and off states of the power switch units 8 and 9 of the bridge arm of the phase B and the power switch units 10 and 11 of the bridge arm of the phase C, such that the inductor of the phase B and the inductor of the phase C alternately perform energy storage for charging and electricity discharge for boost. There is a 180-degree phase difference between charging currents of the windings of the phase B and the windings of the phase C, to alternately perform boost charging of the battery 1.

The condition parameters include at least the voltage of the battery 1 and the voltage of the charging pile 5. The voltage of the battery 1 is a real-time voltage of the battery 1, i.e., a potential difference between positive and negative electrodes of the battery 1, which is a variable rather than a constant, and the voltage of the battery 1 rises or drops with charging or discharging of the battery 1. The voltage of the charging pile 5 is a real-time operating voltage of the charging pile 5, i.e., a charging voltage of the charging pile 5 requested by the battery 1, and the voltage of the charging pile 5 is also a variable rather than a constant. Formula (1) is an expression of a control signal duty cycle D.

$$\\ \begin{matrix}D = \frac{{U}_{pile} - {R}_{s 1} i - {U}_{drop 1}}{{U}_{battery} - {R}_{s 1} i - {U}_{drop 1} + {R}_{s 2} i + {U}_{drop 2}} & ( 1 )\end{matrix}$$

As shown in formula (1), the control signal duty cycle D is related to the voltage U_{battery} of the battery 1, the voltage Uₚᵢₗₑ of the charging pile 5, a wingding current i, a resistance Rₛ₁ in a winding charging circuit, a transistor voltage drop U_{drop1} during winding charging, a resistance Rₛ₂ in a winding discharging circuit, and a transistor voltage drop U_{drop2} during winding discharging. In formula (1), numerical values of U_{drop1}, U_{drop2}, Rₛ₁i, and Rₛ₂i are greatly less than those of U_{battery} and Uₚᵢₗₑ, that is, U_{drop1}, U_{drop2}, Rₛ₁i, and Rₛ₂i have lower degrees of impact on the control signal duty cycle D, while U_{battery} and Uₚᵢₗₑ have higher degrees of impact on the control signal duty cycle D. Therefore, the voltage of the battery 1 and the voltage of the charging pile 5 are determining parameters for the control signal duty cycle and have a high degree of association with the control signal duty cycle. To accurately reflect the control signal duty cycle, it is required to obtain at least the voltage of the battery 1 and the voltage of the charging pile 5, such that the charging mode is selected based on the voltage of the battery 1 and the voltage of the charging pile 5. In one embodiment, a ratio of the voltage of the battery 1 to the voltage of the charging pile 5 is used as the condition parameter. As indicated in formula (1), the voltage of the battery 1 and the voltage of the charging pile 5 affect the control signal duty cycle in the form of the ratio. Different ratios between the voltage of the battery 1 and the voltage of the charging pile 5 correspond to different control signal duty cycles. The ratio of the voltage of the battery 1 to the voltage of the charging pile 5 is obtained, to select the charging mode based on the ratio.

As described above, in addition to the voltage of the battery 1 and the voltage of the charging pile 5, there are a plurality of influencing parameters for the control signal duty cycle, such as the magnitude of a charging current (which is directly associated with a charging power), a current circuit resistor voltage drop, and a current circuit transistor voltage drop. These influencing parameters have low degrees of impact on the control signal duty cycle and have low degrees of association with the control signal duty cycle, cannot accurately reflect the control signal duty cycle alone, and cannot be used alone as condition parameters to guide the selection of the charging mode. However, the influencing parameters can also be used as condition parameters together with the voltage of the battery 1 and the voltage of the charging pile 5. Compared to the case where only the voltage of the battery 1 and the voltage of the charging pile 5 are used as the condition parameters, the addition of the influencing parameters further improves the degree of association between the condition parameters and the control signal duty cycle, such that the condition parameters more accurately reflect the control signal duty cycle. Therefore, in another embodiment, the condition parameters include the voltage of the battery 1, the voltage of the charging pile 5, and one or more influencing parameters.

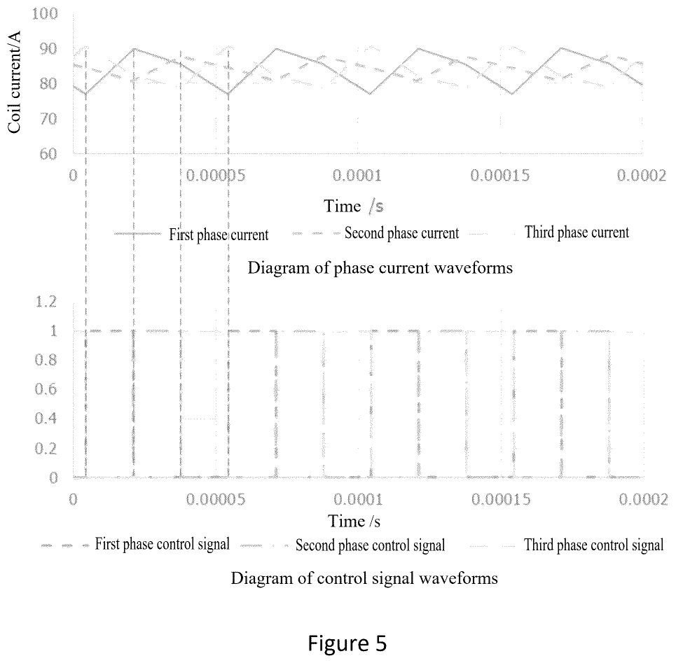

FIG. 5 shows phase current waveforms of the three phase windings of the three-phase alternating current motor 3 in the three-phase charging mode when the ratio of the voltage of the battery 1 to the voltage of the charging pile 5 is 1.5, and waveforms of control signals controlling on and off of all the power switch units 6 to 11 of the three-phase three-arm inverter 2. With reference to FIG. 5, when the ratio of the voltage of the battery 1 to the voltage of the charging pile 5 is 1.5, the duty cycle of the control signal of a bridge arm of each phase is 2/3, and edges of the control signals of the three phase bridge arms overlap. A rising edge of a control signal of a bridge arm of a first phase overlaps a falling edge of a control signal of a bridge arm of a second phase, a falling edge of the control signal of the bridge arm of the first phase overlaps a rising edge of a control signal of a bridge arm of a third phase, and the falling edge of the control signal of the bridge arm of the second phase overlaps the rising edge of the control signal of the bridge arm of the first phase. As such, the current waveform of each phase current has three turning points in one period, reducing the phase current harmonics, reducing the rotor iron loss of the three-phase alternating current motor 3, and reducing the rotor temperature rise of the three-phase alternating current motor 3. Therefore, the ratio of the voltage of the battery 1 to the voltage of the charging pile 5 being 1.5 is referred to as an optimal operating point for the three-phase charging. The charging mode is selected to be the three-phase charging when the ratio of the voltage of the battery 1 to the voltage of the charging pile 5 is 1.5, and the numerical value 1.5 is also referred to as a first threshold. The numerical value 1.5 is an ideal first threshold. As described above, in addition to the ratio of the voltage of the battery 1 to the voltage of the charging pile 5, there are other influencing parameters that affect the control signal duty cycle. In another embodiment, due to the impact of other influencing parameters, the ratio of the voltage of the battery 1 to the voltage of the charging pile 5 that corresponds to the case where the duty cycle of the control signal of the bridge arm of each phase is 2/3 is another numerical value instead of 1.5, and therefore, the first threshold is another numerical value instead of 1.5, such as 1.6 or 1.4.

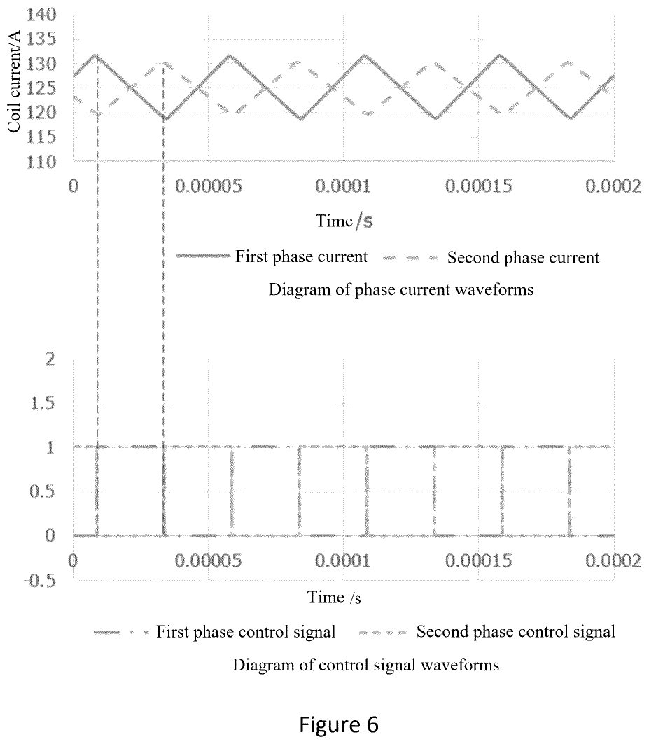

FIG. 6 shows phase current waveforms of two phase windings of the three-phase alternating current motor 3 in the two-phase charging mode when the ratio of the voltage of the battery 1 to the voltage of the charging pile 5 is 2, and waveforms of control signals controlling on and off of power switch units of bridge arms of two phases in the three-phase three-arm inverter 2. Exemplarily, there is no current in a third phase winding. With reference to FIG. 6, when the ratio of the voltage of the battery 1 to the voltage of the charging pile 5 is 2, the duty cycle of the control signal of a bridge arm of each of the two phases is 1/2, and edges of the control signals of the bridge arms of the two phases overlap. A rising edge of a control signal of a bridge arm of a first phase overlaps a falling edge of a control signal of a bridge arm of a second phase, and a falling edge of the control signal of the bridge arm of the first phase overlaps a rising edge of the control signal of the bridge arm of the second phase. As such, the current waveform of each phase current has two turning points in one period, reducing the phase current harmonics, reducing the rotor iron loss of the three-phase alternating current motor 3, and reducing the rotor temperature rise of the three-phase alternating current motor 3. Therefore, the ratio of the voltage of the battery 1 to the voltage of the charging pile 5 being 2 is referred to as an optimal operating point for the two-phase charging. The charging mode is selected to be the two-phase charging when the ratio of the voltage of the battery 1 to the voltage of the charging pile 5 is 2, and the numerical value 2 is also referred to as a second threshold. The numerical value 2 is an ideal second threshold. As described above, in addition to the ratio of the voltage of the battery 1 to the voltage of the charging pile 5, there are other influencing parameters that affect the control signal duty cycle. In another embodiment, due to the impact of other influencing parameters, the ratio of the voltage of the battery 1 to the voltage of the charging pile 5 that corresponds to the case where the duty cycle of the control signal of the bridge arm of each of the two phases is 1/2 is another numerical value instead of 2, and therefore, the first threshold is another numerical value instead of 2, such as 2.1 or 1.9.

It should be understood that the charging mode is not invariable after the selection. As described above, the voltage of the battery 1 and the voltage of the charging pile 5 both change in real time, and the ratio of the voltage of the battery 1 to the voltage of the charging pile 5 changes in real time. Therefore, the charging mode selected based on the ratio also changes in real time. For example, when the ratio is 1.5, the charging mode is selected to be the three-phase charging, and when the ratio is 2, the charging mode is selected to be the two-phase charging, that is, the charging mode is changed from the three-phase charging to the two-phase charging.

As described above, the ratio of the voltage of the battery 1 to the voltage of the charging pile 5 being the first threshold is the optimal operating point for the three-phase charging, and the ratio of the voltage of the battery 1 to the voltage of the charging pile 5 being the second threshold is the optimal operating point for the two-phase charging. In practical application, how to select the charging mode when the ratio of the voltage of the battery 1 to the voltage of the charging pile 5 is a numerical value other than the two optimal operating points of the first threshold and the second threshold is described below. In one embodiment, the charging mode is selected to be the three-phase charging when the ratio of the voltage of the battery 1 to the voltage of the charging pile 5 is less than or equal to the first threshold, the charging mode is selected to be the two-phase charging when the ratio of the voltage of the battery 1 to the voltage of the charging pile 5 is greater than or equal to the second threshold, and the charging mode is kept unchanged when the ratio of the voltage of the battery 1 to the voltage of the charging pile 5 is greater than the first threshold and less than the second threshold. For example, the charging mode is still kept to be the three-phase charging when the ratio of the voltage of the battery 1 to the voltage of the charging pile 5 is increased from being less than or equal to the first threshold to being greater than the first threshold and less than the second threshold, and the charging mode is still kept to be the two-phase charging when the ratio of the voltage of the battery 1 to the voltage of the charging pile 5 is decreased from being greater than or equal to the second threshold to being greater than the first threshold and less than the second threshold.

In another embodiment, selecting the charging mode based on the ratio includes selecting the charging mode to be the three-phase charging when the ratio of the voltage of the battery 1 to the voltage of the charging pile 5 is less than or equal to a third threshold, and selecting the charging mode to be the two-phase charging when the ratio of the voltage of the battery 1 to the voltage of the charging pile 5 is greater than the third threshold. The third threshold is greater than the first threshold and less than the second threshold, and is a switching ratio for the charging mode. The third threshold not only causes the charging mode to be the three-phase charging when the ratio of the voltage of the battery 1 to the voltage of the charging pile 5 is the first threshold and causes the charging mode to be the two-phase charging when the ratio of the voltage of the battery 1 to the voltage of the charging pile 5 is the second threshold, but also causes the charging mode to be the three-phase charging when the ratio of the voltage of the battery 1 to the voltage of the charging pile 5 is close to the first threshold and causes the charging mode to be the two-phase charging when the ratio of the voltage of the battery 1 to the voltage of the charging pile 5 is close to the second threshold, to guide the selection of the charging mode in the case where the ratio of the voltage of the battery 1 to the voltage of the charging pile 5 is a numerical value other than the first threshold and the second threshold, reducing the rotor iron loss of the three-phase alternating current motor 3, and reducing the rotor temperature rise of the three-phase alternating current motor 3. Exemplarily, there is provided a scenario where a charging mode is switched. In the scenario, the voltage of the battery 1 is low, the ratio of the voltage of the battery 1 to the voltage of the charging pile 5 is less than or equal to the third threshold, and the charging mode is selected to be the three-phase charging, in which case the three-phase alternating current motor 3 has a small phase current fluctuation, a small rotor iron loss, and a small rotor temperature rise. As the battery 1 is being charged, the voltage of the battery 1 increases, the ratio of the voltage of the battery 1 to the voltage of the charging pile 5 is greater than the third threshold, and the charging mode is selected to be the two-phase charging, in which case the three-phase alternating current motor 3 has a small phase current fluctuation, a small rotor iron loss, and a small rotor temperature rise. Still exemplarily, there is provided a scenario where a charging mode is not switched. In the scenario, a voltage of a specific charging pile 5 is low, the ratio of the voltage of the battery 1 to the voltage of the charging pile 5 is greater than the third threshold, and the charging mode is selected to be the two-phase charging, in which case the three-phase alternating current motor 3 has a small phase current fluctuation, a small rotor iron loss, and a small rotor temperature rise. As the battery 1 is being charged, the voltage of the battery 1 increases, the ratio of the voltage of the battery 1 to the voltage of the charging pile 5 is still greater than the third threshold, and the charging mode is still kept to be the two-phase charging, that is, the charging mode is kept to be the two-phase charging during the entire boost charging process.

In one embodiment, the first threshold is the above ideal value 1.5, the second threshold is the above ideal value 2, and the third threshold is 1.7. Exemplarily, there is provided a scenario where a charging mode is switched. In the scenario, the battery 1 is in a low state of charge (SOC, i.e., a battery level), the battery 1 has a low voltage of 700 volts, an output voltage of the charging pile 5 is a maximum output of 480 volts, the ratio of the voltage of the battery 1 to the voltage of the charging pile 5 is 1.458, which is less than the third threshold of 1.7, and the charging mode is selected to be the three-phase charging, in which case the three-phase alternating current motor 3 has a small phase current fluctuation, a small rotor iron loss, and a small rotor temperature rise. As the battery 1 is being charged, the battery 1 is in a high SOC, the battery 1 has a high voltage of 900 volts, the ratio of the voltage of the battery 1 to the voltage of the charging pile 5 is 1.875, which is greater than the third threshold of 1.7, and the charging mode is selected to be the two-phase charging, in which case the three-phase alternating current motor 3 has a small phase current fluctuation, a small rotor iron loss, and a small rotor temperature rise. Still exemplarily, there is provided a scenario where a charging mode is not switched. In the scenario, the battery 1 is in a low SOC, the battery 1 has a low voltage of 700 volts, the charging pile 5 is one of few quick charging piles in the market and has a low voltage, an output voltage of the charging pile 5 is a maximum output of 380 volts, the ratio of the voltage of the battery 1 to the voltage of the charging pile 5 is 1.842, which is greater than the third threshold of 1.7, and the charging mode is selected to be the two-phase charging, in which case the three-phase alternating current motor 3 has a small phase current fluctuation, a small rotor iron loss, and a small rotor temperature rise. As the battery 1 is being charged, the voltage of the battery 1 increases, the ratio of the voltage of the battery 1 to the voltage of the charging pile 5 is still greater than the third threshold of 1.7, and the charging mode is still kept to be the two-phase charging, that is, the charging mode is kept to be the two-phase charging during the entire boost charging process. In another embodiment, the first threshold is the above ideal value 1.5, the second threshold is the above ideal value 2, and the third threshold is another numerical value between 1.5 and 2. In yet another embodiment, the first threshold is not the above ideal value 1.5, the second threshold is not the above ideal value 2, and the third threshold is a numerical value between the first threshold and the second threshold.

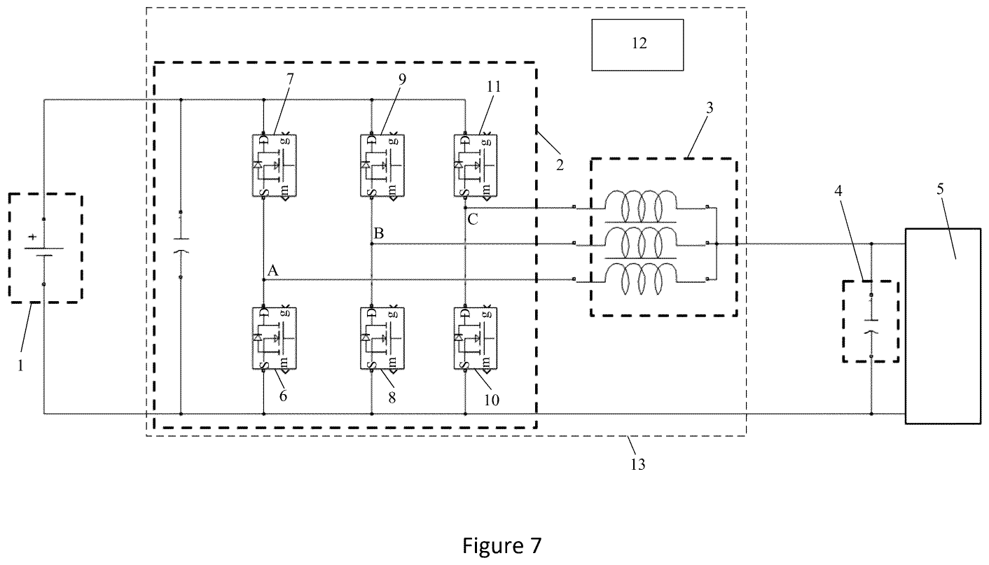

FIG. 7 shows a structure of an electric drive apparatus 13. As shown in FIG. 7, the electric drive apparatus 13 includes the inverter 2 and the three-phase motor 3 in the above battery boost charging circuit, where the inverter 2 and the three-phase motor 3 may be configured as described. The electric drive apparatus 13 further includes a controller 12 that performs the boost charging control method described above. The controller 12 may control on and off of each of the power switch units 6 to 11 of the inverter 2, and is, for example, electrically connected to each of the power switch units 6 to 11. The controller 12 may obtain the voltage of the battery 1 by, for example, communicating with a system that manages the battery 1. The controller 12 may obtain the voltage of the charging pile 5 by, for example, obtaining the charging voltage of the charging pile 5 requested by the system that manages the battery 1. The electric drive apparatus 13 may be provided in a vehicle, and the battery 1 may be a traction battery for the vehicle.

The present disclosure is disclosed above with the embodiments, which, however, are not intended to limit the present disclosure. Any person skilled in the art can make possible changes and modifications without departing from the spirit and scope of the present disclosure.

### LIST OF REFERENCE NUMERALS

1: battery;
2: three-phase three-arm inverter;
3: three-phase alternating current motor;
4: support capacitor;
5: charging pile;
6: first power switch unit;
7: second power switch unit;
8: third power switch unit;
9: fourth power switch unit;
10: fifth power switch unit;
11: sixth power switch unit;
12: controller;
13: electric drive apparatus

1. A boost charging control method performed on a battery using a three-phase motor and an inverter, the method comprising:
obtaining a condition parameter, the condition parameter being associated with a duty cycle of a control signal of a power switch unit of the inverter, and the condition parameter comprising a battery voltage and a charging pile voltage;
selecting a charging mode based on the condition parameter, wherein the charging mode comprises two-phase charging and three-phase charging,
wherein in the two-phase charging, the power switch unit of the inverter is controlled such that two phase windings of the three-phase motor are used for boost charging of the battery, and
wherein in the three-phase charging, the power switch unit of the inverter is controlled such that three phase windings of the three-phase motor are used for boost charging of the battery; and
controlling charging based on the charging mode.

2. The boost charging control method according to claim 1,
wherein the condition parameter comprises a ratio of the battery voltage to the charging pile voltage.

3. The boost charging control method according to claim 2,
wherein selecting the charging mode based on the condition parameter comprises selecting the charging mode based on the ratio, and wherein selecting the charging mode based on the ratio comprises:
selecting the three-phase charging in response to the ratio being less than or equal to a first threshold;
selecting the two-phase charging in response to the ratio being greater than or equal to a second threshold; and
keeping the charging mode unchanged in response to the ratio being greater than the first threshold and less than the second threshold.

4. The boost charging control method according to claim 3, wherein the first threshold is 1.5.

5. The boost charging control method according to claim 3, wherein the second threshold is 2.

6. The boost charging control method according to claim 2, wherein selecting the charging mode based on the condition parameter comprises selecting the charging mode based on the ratio, and wherein selecting the charging mode based on the ratio comprises:
selecting the three-phase charging in response to the ratio being less than or equal to a third threshold; and
selecting the two-phase charging in response to the ratio being greater than the third threshold.

7. The boost charging control method according to claim 6, wherein the third threshold is 1.7.

8. The boost charging control method according to claim 1, wherein:
in the two-phase charging, the power switch unit of the inverter is controlled such that there is a 180-degree phase difference between charging currents of the two phase windings of the three-phase motor; and
in the three-phase charging, the power switch unit of the inverter is controlled such that there is a 120-degree phase difference between charging currents of the three phase windings of the three-phase motor.

9. An electric drive apparatus, comprising:
an inverter;
a three-phase motor; and
a controller,
wherein the inverter is configured to perform power conversion between a battery and the three-phase motor, and
wherein the controller is configured to:
obtain a condition parameter, the condition parameter being associated with a duty cycle of a control signal of a power switch unit of the inverter, and the condition parameter comprising a battery voltage and a charging pile voltage;
select a charging mode based on the condition parameter, wherein the charging mode comprises two-phase charging and three-phase charging,
wherein in the two-phase charging, the power switch unit of the inverter is controlled such that two phase windings of the three-phase motor are used for boost charging of the battery, and
wherein in the three-phase charging, the power switch unit of the inverter is controlled such that three phase windings of the three-phase motor are used for boost charging of the battery; and
control charging based on the charging mode.

10. The electric drive apparatus according to claim 9,
wherein the condition parameter comprises a ratio of the battery voltage to the charging pile voltage.

11. The electric drive apparatus according to claim 10,
wherein the controller is configured to select the charging mode based on the condition parameter by selecting the charging mode based on the ratio, wherein, to select the charging mode based on the ratio, the controller is configured to:
select the three-phase charging in response to the ratio being less than or equal to a first threshold;
select the two-phase charging in response to the ratio being greater than or equal to a second threshold; and
keep the charging mode unchanged in response to the ratio being greater than the first threshold and less than the second threshold.

12. The electric drive apparatus according to claim 11, wherein the first threshold is 1.5.

13. The electric drive apparatus according to claim 11, wherein the second threshold is 2.

14. The electric drive apparatus according to claim 10,
wherein the controller is configured to select the charging mode based on the condition parameter by selecting the charging mode based on the ratio, wherein to select the charging mode based on the ratio, the controller is configured to:
select the three-phase charging in response to the ratio being less than or equal to a third threshold; and
select the two-phase charging in response to the ratio being greater than the third threshold.

15. The electric drive apparatus according to claim 14, wherein the third threshold is 1.7.

16. The electric drive apparatus according to claim 9, wherein:
in the two-phase charging, the power switch unit of the inverter is controlled such that there is a 180-degree phase difference between charging currents of the two phase windings of the three-phase motor; and
in the three-phase charging, the power switch unit of the inverter is controlled such that there is a 120-degree phase difference between charging currents of the three phase windings of the three-phase motor.

17. A vehicle, comprising:
the electric drive apparatus according to claim 9.
